(19) United States
(12) Patent Application Publication
(10) Pub. No.: US 2007/0179760 A1
(43) Pub. Date: Aug. 2, 2007

(54) Method of determining graph isomorphism in polynomial-time

(75) Inventor: Joshua R. Smith, Seattle, WA (US)

Correspondence Address: INTEL CORPORATION;c/o INTELLEVATE, LLC, P.O. BOX 52050, MINNEAPOLIS, MN, 55402, US

(73) Assignee: Intel Corporation

(21) Appl. No.: 11/326,971

(22) Filed: Jan. 6, 2006

(51) Int. Cl. G06F 17/10

(52) U.S. Cl. 703/2

(57) ABSTRACT

Generating a complete graph invariant may be accomplished by initializing each card of an initial message deck to an identity matrix, propagating messages to form a first iteration message deck using a message propagation rule, generating a first iteration codebook using the first iteration message deck, recoding the first iteration message deck using the first iteration codebook, repeating the propagating, generating, and recoding steps for at least a second iteration, concatenating the message decks elementwise to form a final message deck, row sorting the final message deck to form a row sorted message deck, sorting rows of the row sorted message deck to form a table sorted message deck, and sorting cards of the table sorted message deck to form the invariant.

### BACKGROUND

1. Field

The present invention relates generally to graph theory in communications and information technology systems and, more specifically, to determining whether two graphs are isomorphic in polynomial-time.

2. Description

A graph is a collection of points and lines connecting some (possibly empty) subset of pairs of points. Points are typically called vertices or nodes, and lines are typically called edges. The edges of graphs may have directedness. A graph in which the edges have no direction is called an undirected graph. For an undirected graph, an unordered pair of vertices that specify a line joining these two vertices is said to form an edge. For a directed graph, the edge may be represented by an ordered pair of vertices. The degree of a vertex is the number of edges which touch the vertex. Graphs exist in a wide variety of types. The most common type of graph, called a simple graph, is one that has at most one edge that connects any two vertices, and no “self edges,” or loops. The edges, vertices, or both of a graph may be assigned specific values, labels, or colors, in which case the graph is called a labeled graph.

The study of graphs is known as graph theory. Graphs are general data representations that may encode any finite algebraic or combinatorial structure. The study of various paths in graphs such as Euler paths, Eulerian circuits, Hamiltonian paths, and Hamiltonian circuits, has many practical applications in real-world problems. Methods employing graph theory may be useful in practical applications in the fields of physics, biology, chemistry, bioinformatics, database systems, storage, information search and retrieval, communications, machine learning, statistics, economics, social sciences, information technology and computer science, among others.

The study of how to classify problems based on how difficult they are to solve is called complexity theory. A problem is assigned to the problem class P (polynomial-time computable) if the number of steps needed to solve the problem is bounded by a polynomial (i.e., some constant power of the problem's size). A problem is assigned to the problem class NP (non-deterministic polynomial-time computable) if the problem permits a nondeterministic solution and the number of steps to verify the solution is bounded by some constant power of the problem's size. The class P is a subset of the class NP, but there also exist problems which are not in NP. If a problem is known to be in NP, its solution can be verified in polynomial-time. A problem is NP-complete if it is both in NP (verifiable in nondeterministic polynomial-time) and NP-hard (any problem in NP can be translated into this problem).

Isomorphism refers to a mapping that preserves sets and relationships among elements. Two graphs which contain the same number of vertices connected in the same way are said to be isomorphic. Formally, two graphs G and H with vertices Vₙ={1, 2, . . . , n} are said to be isomorphic if there is a permutation p of Vₙ such that {u, v} is in the set of edges E(G) IFF {p(u), p(v)} is in the set of edges E(H). A permutation is a rearrangement of the elements of an ordered list into a one-to-one correspondence with the list itself. Determining if two graphs are isomorphic is generally not recognized in the prior art as being an NP-complete problem, nor is it known to be a P-problem. Its computational complexity has been considered unknown. In fact, some scientists posit that the complexity class called graph isomorphism complete, the class of problems that are equivalent to graph isomorphism, are entirely disjoint from both the NP-complete problems and from P. A solution to the graph isomorphism problem allows one to efficiently determine, for any pair of finitely described structures (not just graphs), whether they are actually different, or merely different representations of a single underlying object. This has many practical uses in various fields of science and technology.

A polynomial-time algorithm for testing graph isomorphism is known when the maximum vertex degree is bounded by a constant (E. M. Luks, “Isomorphism of Graphs of Bounded Valence Can Be Tested in Polynomial Time” J. Comput. System Sci. 25, p. 4249, 1982; S. Skiena, “Graph Isomorphism” §5.2 in Implementing Discrete Mathematics: Combinatorics and Graph Theory with Mathematica, Reading, Mass., Addison-Wesley, pp. 181-187, 1990). However, since this algorithm requires a constant bound to maximum vertex degree, it is not general, nor is it complete. Polynomial-time algorithms for isomorphism testing in many other restricted classes of graphs are known as well.

There is no invariant for testing general, arbitrary graphs to determine isomorphism in the prior art that is known to be complete and computable in polynomial-time algorithm.

### BRIEF DESCRIPTION OF THE DRAWINGS

The features and advantages of the present invention will become apparent from the following detailed description of the present invention in which:

FIG. 1 is a flow diagram of high level processing of an embodiment of the present invention;

FIG. 2 illustrates two sample graphs, adjacency matrices and processing according to an embodiment of the present invention;

FIG. 3 is a block diagram illustrating a computing platform according to an embodiment of the present invention;

FIG. 4 shows a diagram of the message deck U according to an embodiment of the present invention;

FIG. 5 shows a diagram of the transform S according to an embodiment of the present invention;

FIG. 6 shows a diagram of invariant V according to an embodiment of the present invention;

FIG. 7 is a flow diagram of invariant generation processing according to a first embodiment of the present invention; and

FIG. 8 is a flow diagram of invariant generation processing according to a second embodiment of the present invention.

### DETAILED DESCRIPTION

Embodiments of the present invention comprise a method and apparatus for generating a complete graph invariant for graph isomorphism testing that is computable in polynomial-time. Isomorphism checking reduces to checking equality of the graph invariant values. This shows that graph isomorphism is in P. A graph invariant is a function of a graph that is independent of the labeling of the graph. In other words, the invariant is a function that will return the same value for any permutation of the graph. Hence, a graph invariant will return the same value when applied to two graphs that are isomorphic. However, the ability to compute a graph invariant is not sufficient to solve graph isomorphism, because the invariant must also be guaranteed to return different values when presented with non-isomorphic graphs. An invariant with this property is known as a complete invariant.

The polynomial-time computable complete invariant of embodiments of the present invention can be conveniently computed by a message passing algorithm defined on the graph. In recent years, message passing algorithms defined on graphs have been highly successful in efficiently computing probabilistic quantities. They have been applied with great effect to a variety of inference problems, from iterative decoding of error correcting codes, to machine vision, and others. In the message passing prior art thus far, graphs have been considered simply as a tool for representing probability distributions. Embodiments of the present invention introduce a message passing algorithm whose purpose is to compute a quantity called the complete invariant that pertains to the graph itself. In particular, the invariant is based on the dynamics of message propagation on the graph.

Reference in the specification to “one embodiment” or “an embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

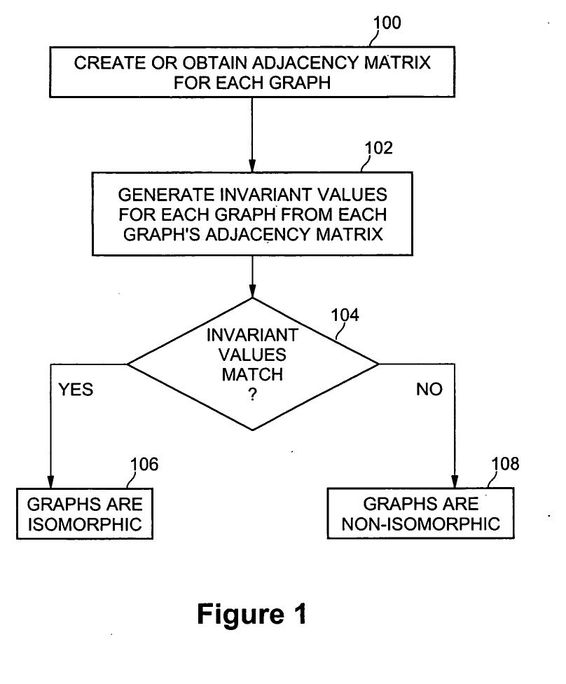

FIG. 1 is a flow diagram of high level processing of an embodiment of the present invention. This process determines if two undirected simple graphs are isomorphic. In one embodiment, this process may be implemented in software executed by a computer system. At block 100, an adjacency matrix may be created or obtained for each of the two graphs. An adjacency matrix of a simple graph is a matrix with rows and columns labeled by graph vertices, with a 1 or 0 in position (vᵢ, vⱼ) of the matrix according to whether vᵢ and vⱼ are adjacent or not. In a graph, two graph vertices are adjacent if they are joined by a graph edge. For a simple graph with no self-loops, the adjacency matrix must have 0s on the diagonal. For an undirected graph, the adjacency matrix is symmetric. In one embodiment, the adjacency matrix may be implemented as a data structure stored in memory within the computer system. At block 102, invariant values may be generated for each graph from the adjacency matrix for each graph. Further details on how the invariant values for a graph may be generated according to embodiments of the present invention are shown below. At block 104, the invariant values for each graph may be compared to each other. If the invariant values match (e.g., are equal), then the graphs are isomorphic at block 106. If the invariant values do not match, then the graphs are non-isomorphic at block 108.

The result of the isomorphism testing on the graphs may be used in subsequent application specific processing. For example, it may be determined whether two chemical structures represented by graphs are identical or non-identical, or whether two protein interaction networks represented by graphs are identical or not. A graph may be indexed and stored according to its invariant. Thus when a protein interaction network has been mapped in a laboratory experiment, its complete invariant can be computed according to embodiments of the present invention. Then a database of known protein interaction networks, indexed by the complete invariant of the present invention, can be searched to determine whether the newly measured network is already known, or is previously unknown. If it was not previously known, a new record may be created, and the complete-invariant-based index updated. In one embodiment, graphs will be indexed and stored as an ordered pair consisting of the graph invariant, and an adjacency matrix representation of the graph. In another embodiment, the graphs will be indexed and stored as an ordered pair consisting of the graph invariant, and the graph transform, described later. The invariant facilitates searching and provides a standard form for graph interchange and reference. The conjoined adjacency matrix or transform representation is convenient since it provides an explicit and concrete representation of one realization of the graph. This enables a de facto or standards-based canonical representation of the graph, even if embodiments of the present invention do not directly provide a canonical graph representation. Many other practical uses of graph invariants are known in the art.

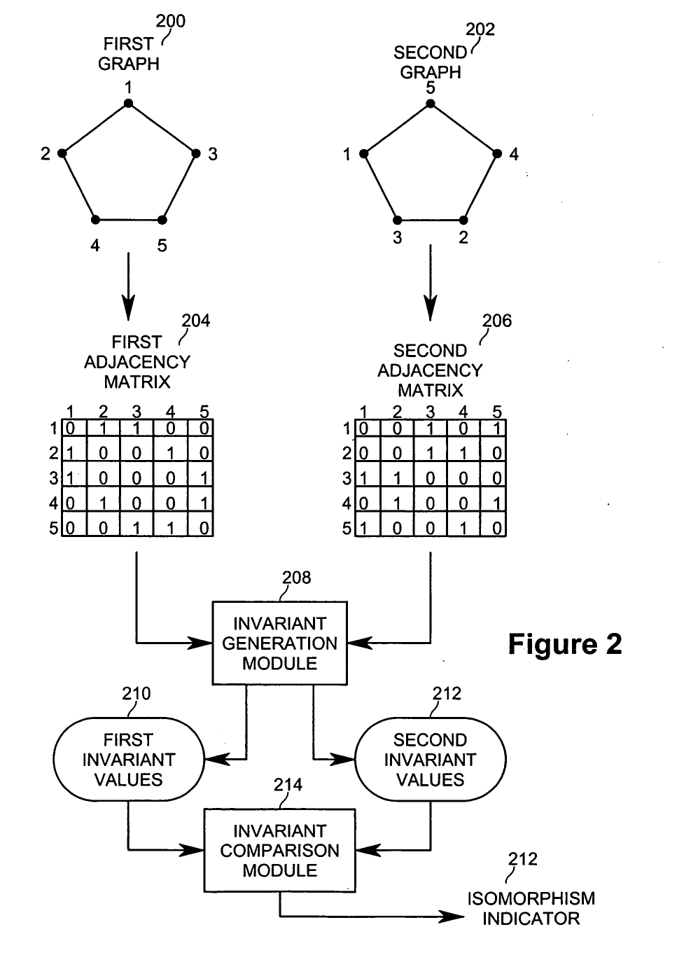

FIG. 2 illustrates two sample graphs, adjacency matrices and processing according to an embodiment of the present invention. For purposes of clarity of illustration, two very simple graphs are shown. It will be understood that one embodiment of the present invention is applicable to undirected simple graphs of any number of vertices and edges. Other embodiments may be applicable to other types of graphs. The first graph 200 has five vertices and five edges. The second graph 202 also has five vertices and five edges. The vertices may be labeled as shown. In this simple example, one can readily see that the graphs are the same. However, in other cases, the graphs may be arbitrarily complex (involving any number of vertices and edges) and the isomorphism or non-isomorphism will not be easily detectable by viewing the graphs. A first adjacency matrix 204 may be generated or obtained to represent the first graph. A second adjacency matrix 206 may be generated or obtained to represent the second graph. The adjacency matrices of the graphs may be input to invariant generation module 208. In another embodiment, adjacency lists may be used instead of adjacency matrices. When operating on first adjacency matrix 204 as input data, the invariant generation module generates first invariant values 210 as output data according to methods shown in further detail below. When operating on second adjacency matrix 206 as input data, the invariant generation module generates second invariant values 212 as output data according to those same methods. The first and second invariant values may be forwarded to invariant comparison module 214. The invariant comparison module compares the first invariant values to the second invariant values. If they match (e.g., are equal), then the invariant comparison module outputs an isomorphism indicator of true. If they do not match, the invariant comparison module outputs an isomorphism indicator of false.

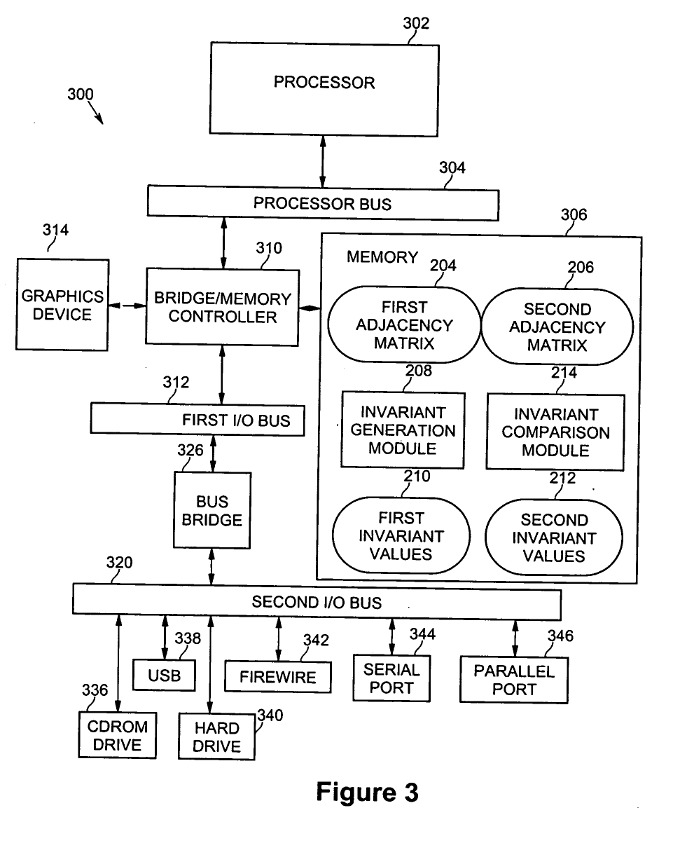

An exemplary computing platform for embodiments of the present invention is shown in FIG. 3, however, other systems may also be used and not all components of the computing platform shown are required for the present invention. Sample system 300 may be used, for example, to execute the processing for embodiments of the present invention. Sample system 300 is representative of processing systems based on the PENTIUM® family of processors and CELERON® processors available from Intel Corporation, although other systems (including personal computers (PCs) or servers having other processors, engineering workstations, other set-top boxes, and the like) and processing architectures may also be used.

FIG. 3 is a block diagram of a computing system 300 of one embodiment of the present invention. The system 300 includes at least one processor 302 that processes data signals. Processor 302 may be coupled to a processor bus 304 that transmits data signals between processor 302 and other components in the system 300. Processor 302 may comprise multiple processors and multiple processing cores in any combination. Computing system 300 includes a memory 306. Memory 306 may store instructions and/or data represented by data signals that may be executed by processor 02. The instructions and/or data may comprise code for performing any and/or all of the techniques of the present invention. Memory 306 may contain software and/or data such as first adjacency matrix 204, second adjacency matrix 206, invariant generation module 208, invariant comparison module 214, first invariant values 210, and second invariant values 212.

A bridge/memory controller 310 may be coupled to the processor bus 304 and memory 306. The bridge/memory controller 310 directs data signals between processor 302, memory 306, and other components in the computing system 300 and bridges the data signals between processor bus 304, memory 306, and a first input/output (I/O) bus 312. In this embodiment, graphics device 314 interfaces to a display device (not shown) for displaying images rendered or otherwise processed by the graphics device 314 to a user. First I/O bus 312 may comprise a single bus or a combination of multiple buses. First I/O bus 312 provides communication links between components in system 300.

A second I/O bus 320 may comprise a single bus or a combination of multiple buses. The second I/O bus 320 provides communication links between components in system 300. A bus bridge 326 couples first I/O bridge 312 to second I/O bridge 320. One or more other peripheral devices may be coupled to the second I/O bus. Other conventional and well known peripherals and communication mechanisms may also be coupled to the second I/O bus, such as compact disk read only memory (CDROM) drive 336, universal serial bus (USB) 338, hard drive 340, FireWire bus 342, serial port 344, and parallel port 346. Hard drive 340 may, at times, store one or more of first adjacency matrix 204, second adjacency matrix 206, invariant generation module 208, invariant comparison module 214, first invariant values 210, and second invariant values 212.

Embodiments of the present invention are related to the use of the system 300 as a component in a processing system. According to one embodiment, such processing may be performed by the system 300 in response to processor 302 executing sequences of instructions in memory 306. Such instructions may be read into memory 306 from another computer-readable medium, such as hard drive 340, for example. Execution of the sequences of instructions causes processor 302 to execute processing for the application according to embodiments of the present invention. In an alternative embodiment, hardware circuitry may be used in place of or in combination with software instructions to implement portions of embodiments of the present invention. Thus, the present invention is not limited to any specific combination of hardware circuitry and software. For example, invariant generation module 208 and invariant comparison module 214 may be implemented in circuitry.

The elements of system 300 perform their conventional functions in a manner well-known in the art. In particular, hard drive 340 may be used to provide long-term storage for the executable instructions and data structures for embodiments of components in accordance with the present invention, whereas memory 306 is used to store on a shorter term basis the executable instructions of embodiments of components in accordance with the present invention during execution by processor 302.

In embodiments of the present invention, to compute the invariant for an adjacency matrix A, a message-passing algorithm may be used to compute a message deck U(A), and, in one embodiment, a related adjacency matrix transform S(A). Both U(A) and S(A) are permutation-dependent. The elements of the message deck may be sorted into a modified lexicographic order to find the invariant V(A).

In one embodiment, the transform S(A) encodes the same information as the adjacency matrix A, but presents it in a different form. If the invariant V really is complete, then it must encode the structure of the graph; if V is indeed invariant, then it must not retain any information about the labeling of the graph as it was input to the invariant generation module (by contrast, this labeling information is present in transform matrix S). That the invariant encodes the graph structure means that it must be possible in principle (in the absence of restrictions on computational complexity) to determine the structure of the graph given only the graph's invariant. To see that any complete invariant must (at least implicitly) encode the structure of the graph, observe that the adjacency matrices corresponding with the invariant can in principle be found by trying (i.e., computing the invariant of) every adjacency matrix of the correct size and throwing away the trials that do not produce the desired invariant. If the invariant is indeed complete, then all the adjacency matrices that produce a particular invariant must in fact be representations of a unique graph. This establishes that any complete invariant effectively encodes the structure of the graph. Incidentally, it also implies that given any pair of adjacency matrices that produce the same complete invariant, it must be possible to permute the adjacency matrices to make them identical.

The adjacency matrix encodes a graph and a particular labeling. The adjacency matrix uses just two symbols, 0 and 1, and encodes the information about the graph structure and labeling by the relative position of these symbols in the matrix. One can think of the graph as being represented in a fully distributed fashion: it is the ensemble of symbols and their relative positions that encodes the graph's structure and labeling. A single symbol considered in isolation conveys very little information about the graph. The effect of the transform S(A) is to re-encode the graph's structure using a larger alphabet, where each symbol considered individually conveys more information about the graph's structure than a single 1 or 0 adjacency matrix symbol. Using this alternate representation, the relative positions of the symbols in the matrix are no longer required to encode the graph's structure, and so the matrix can be sorted in specific fashion, discarding all labeling information and yielding an invariant.

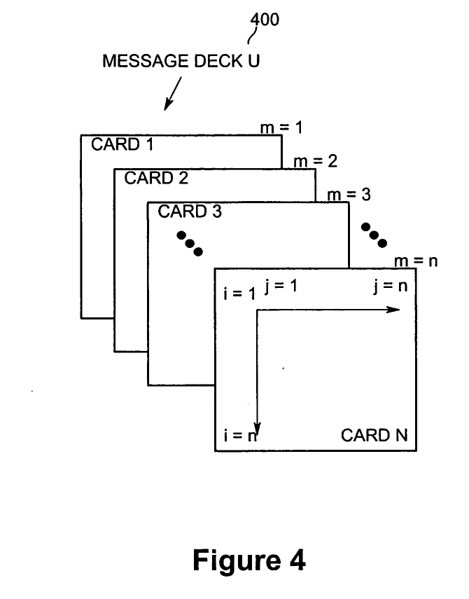

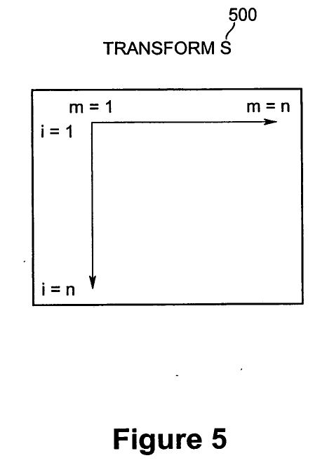

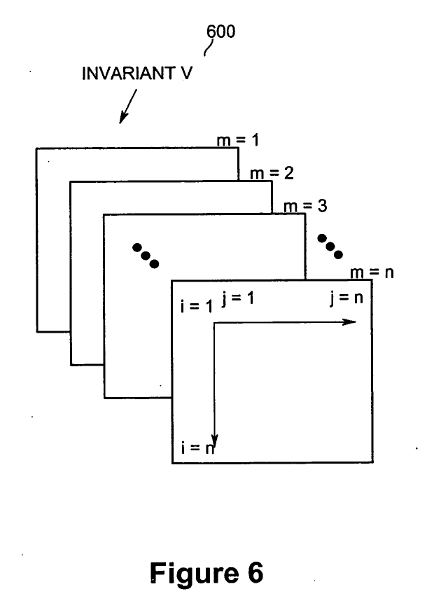

The transform matrix S is a two dimensional (n×n) table of strings, where n is the number of vertices in the graph. To compute the transform, first compute a three dimensional (n×n×n) table of strings called message deck U. FIG. 4 shows a diagram of the message deck U 400 according to an embodiment of the present invention. Three indices may be used to identify the entries of U: m, i, and j. The three-dimensional table of strings U may be described as a “deck” of “cards,” with each card corresponding to a single m value. Printed on each card is a two-dimensional table of strings. The m index identifies the “mixer” node, and a corresponding card in the message deck U. Messages received from a graph vertex (e.g., node) labeled m will be treated differently than messages received from other vertices (nodes). The rows of the adjacency matrix A and of message deck U will be indexed by i; the columns of the adjacency matrix A and of message deck U will be indexed by j. Since the entries at location (i, j) on each card in U correspond to the adjacency matrix entry at location (i, j), each card may be thought of as a different “view” or “projection” of the adjacency matrix A. FIG. 5 shows a diagram of transform matrix S 500 according to an embodiment of the present invention. Transform matrix S is formed from message deck U by sorting the contents of each row into a modified lexicographic order, and “recoding” according to processing as described below. The invariant V is a three dimensional table of strings whose order does not depend on the labeling of the input graph. FIG. 6 shows a diagram of invariant V 600 according to an embodiment of the present invention.

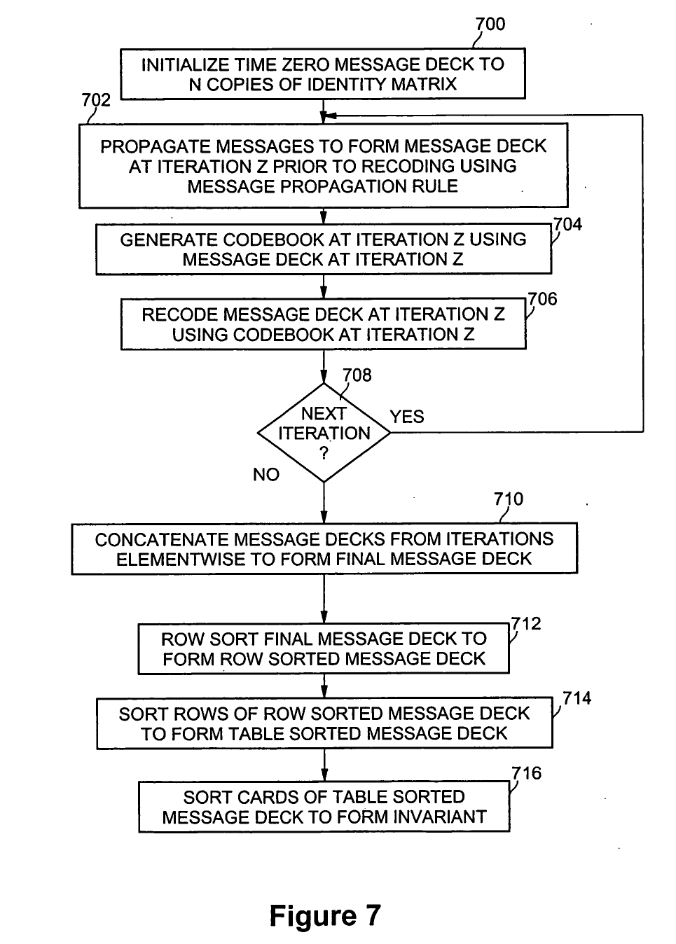

FIG. 7 is a flow diagram of invariant generation processing according to a first embodiment of the present invention. These steps may be performed by an invariant generation module based on a graph's adjacency matrix in order to generate the invariant values for the graph.

This embodiment is also shown below in Table I.

TABLE I

1. Initialize U⁰ matrix
2. Propagate to find U¹
3. Recode to find U¹ and Û¹
4. Propagate to find U²
5. Recode to find U² and Û²
6. Concatenate U¹ and U² elementwise to form U
7. Row sort U to form R
8. Sort rows of R to form T
9. Sort cards of T to form V

The message deck U(A) of an n×n adjacency matrix A may be computed by a series of message-passing operations. At block 700 of FIG. 7, invariant generation processing begins by initializing the message deck at time step zero (U⁰). A superscript above U will indicate the time step at which the message deck was produced. The final matrix U, with no superscript (called a final message deck herein), will be found by concatenating strings within message decks having superscripts. At time step zero, each card in the message deck may be set to the identity matrix (1's in the diagonal elements of a card of U⁰, 0's in all other elements of a card of U⁰). Since there are n cards in the message deck, there are now n copies of the identity matrix in U⁰. Thus, at time step zero, each card of U⁰ is initialized to 1's on the diagonal and 0's off-diagonal:
Uₘᵢⱼ⁰=δᵢⱼ Equation 1
for all iε{1, . . . , n} and all jε{1, . . . , n}, where the delta is the Kronecker delta function. Equivalently, one could write Uₘ⁰=I, ∀mε{1, . . . , n}, where I is the n×n identity matrix. No numerical computations will be used on the symbols, and in principle any two distinguishable symbols could be used, not just 0 and 1.

At a first iteration time step z=1, at block 702 a message may be propagated to form the message deck at iteration z (e.g., 1) prior to recoding using a message propagation rule. In one embodiment of the present invention, a message propagation rule with the mixer node enabled, is as follows. Messages received from the mixer node are pulled into a unique position (the first position in the list is used, although other conventions are possible) that does not get sorted. In computing the message deck, each node is set to be the mixer node once. The message propagation rule specifies how to compute the time step z+1 messages given the time step z messages and the adjacency matrix A. The rule can be expressed:

$${\underline{U}}_{mij}^{z + 1} ( A ) = {U}_{mim}^{z} {A}_{mj} {⋃}_{k = \{ 1 … n \} \backslash m } {U}_{mik}^{z} {A}_{kj} \qquad Equation 2$$

The concatenation of symbols U and A above does not represent multiplication, but string concatenation. Also, the set implied by the union should be taken to be a multiset. That is, the number of times a symbol is repeated in the union is significant. Equivalently, the union over k operations may also be thought of as the operation of sorting the n-tuple of strings that are indexed by k. The underline below the initial U indicates that recoding, which is explained below, has not yet occurred. The symbol U without the underline denotes the recoded version of the message. The combination of concatenation and set notation on the right hand side, used to define a message, requires some additional explanation. Here is the message update rule written more formally to clarify the meaning of the notation:

$${\underline{U}}_{mij}^{z + 1} ( A ) = ( ( {U}_{mim}^{z} , {A}_{mj} ) , {⋃}_{k = \{ 1 … n \} \backslash m } \{ ( {U}_{mik}^{z} , {A}_{kj} ) \} ) . \qquad Equation 3$$

Formally, the right hand side is an ordered pair, which is denoted (h, b) (for header and body). The first element of the ordered pair, h, is itself an ordered pair, whose elements are a message and an adjacency matrix entry. The second element, b, is a multiset of ordered pairs, each of which has the same form as the header. Recoding will replace this structure (the right hand side) with a simple string.

In a practical computer system implementation, this union of multisets corresponds to sorting a list of strings and then concatenating them. The ordered pairs correspond to concatenation. It is necessary to ensure that the code is uniquely decodable, meaning that the concatenation operation does not introduce ambiguity about the identity (i.e., starting and stopping characters) of code words. This requirement is handled in one implementation by having a recoding operator output strings that are identical in length. In other embodiments, the recoding operator could ensure that the code is uniquely decodable by using a more sophisticated prefix-free code, or by introducing punctuation (such as the parentheses and comma used in our explanation above).

An example is now shown using C₅, a cycle graph on 5 vertices as depicted in FIG. 2. C₅, is a strongly regular graph with parameters (n, k, λ, μ)=5,2,0,1. A strongly regular graph with parameters (n, k, λ, μ) has n vertices and k edges per node. Adjacent vertices have A neighbors in common, and non-adjacent vertices have p neighbors in common. Because of their high degree of symmetry, non-isomorphic pairs of strongly regular graphs with the same parameter sets are often not distinguishable by most prior art isomorphism testing methods.

For example, compute U₋₁₂₃¹(A) (where A=C₅), the un-recoded time step 1 message appearing on card 1 at row 2, column 3. A denotes an adjacency matrix representation of this graph. Subscripts after A will refer to row and column entries of the adjacency matrix.

$$Let A = {C}_{5} = \begin{matrix}0 & 1 & 1 & 0 & 0 \\ 1 & 0 & 0 & 1 & 0 \\ 1 & 0 & 0 & 0 & 1 \\ 0 & 1 & 0 & 0 & 1 \\ 0 & 0 & 1 & 1 & 0\end{matrix}$$

In one embodiment, the adjacency matrix entry may be placed before the message from the previous time step (so the order of A and U can be swapped as compared with the exposition elsewhere herein).

$${\underline{U}}_{123}^{1} ( A ) = {A}_{13} {U}_{121}^{0} {⋃}_{k = \{ 1 … n \} \backslash 1 } {A}_{k 3} {U}_{12 k}^{0} \qquad Equation 4$$

U₋₁₂₃¹(A)=(A₁₃U₁₂₁⁰,A₂₃U₁₂₂⁰∪A₃₃U₁₂₃⁰∪A₄₃U₁₂₄⁰∪A₅₃U₁₂₅⁰) Equation 5
Replacing the U⁰ values results in:
U₋₁₂₃¹(A)=(A₁₃0,A₂₃1∪A₃₃0∪A₄₃0∪A₅₃0) Equation 6
Inserting the adjacency matrix entries, results in:
U₋₁₂₃¹(A)=(10,01∪00∪00∪10) Equation 7
The union of sets is implemented in practice as a sorting of the list. The “pipe” symbols (“I”) have been inserted for readability.
U₋₁₂₃¹(A)=(10,00|00|01|10) Equation 8
U₋₁₂₃¹(A)=1000000110 Equation 9

The expression for U₋ₘᵢⱼ^{z+1}(A) represents a single entry in the message deck U at time step z+1 before recoding. Similar processing may be done for all entries in the message deck. The entire three-dimensional message deck U is a nested n-tuple, with 3 layers of nesting (essentially a three-dimensional matrix). The invariant is a nested multiset with 3 layers of nesting (plus some additional structure to be explained below). In other words, the distinction between message deck U and invariant V is that U preserves order information, and V does not. In practice, V is formed from U by sorting appropriately, respecting the nesting. Specifically, the messages within each row are sorted into lexicographic order, then the rows on each card are sorted row-wise into lexicographic order (without modifying the contents of any row or any card), and finally the cards are sorted into lexicographic order, changing the order of the cards but not the multiset of messages on any card, or the (sorted) order of the messages on any card.

To reduce the size of the message strings, recoding may be done after each message propagation step. Recoding replaces longer messages with shorter equivalents according to a codebook. At block 704, a codebook at iteration z may be generated using the message deck at iteration z. At block 706, the message deck at iteration z may be recoded using the codebook from iteration z. To generate the codebook for time step z, the messages produced throughout the graph at time z are enumerated with no repetitions, put in lexicographic order, and then paired with increasing integers or some other suitable index string. Integers represented as hexadecimal numbers may be used in one embodiment. Mathematically, the codebook is a set (not a multiset) of ordered pairs, where the pairs consist of a message from the message set, and its index. In recoding, the long message strings generated at each time step are compressed by replacing them with shorter code words from the codebook. Specifically, after propagation step z, the codebook for that time step is generated, and each of the (long) strings in the “un-recoded” deck is replaced by its shorter equivalent from the codebook before the next propagation step occurs.

The set of code words in the codebook for time step z can be written

$${\hat{U}}^{z} = {⋃}_{m = 1}^{n} {⋃}_{i = 1}^{n} {⋃}_{j = 1}^{n} {\underline{U}}_{mij}^{z} . \qquad Equation 10$$

The entity Û^{z} is a set, not a multiset. Also, the union in this expression is not intended to preserve nesting of sets. The entity Û^{z} is an ordinary set, not a nested set of sets, by contrast with the invariant to be described below. The codebook itself is a set of ordered pairs and can be written

$${C}^{z} = {⋃}_{y = 1}^{\vert {\hat{U}}^{z} \vert} ( y , {\hat{U}}_{y}^{z} ) \qquad Equation 11$$

In Equation 11, Û_{y}^{z} is the y'th element of the set Û^{z}. In this example, 1 (rather than 0) is used as the first recoding index. Explicitly expressing the recoding operation results in:

$$\begin{matrix}{U}_{mij}^{z + 1} ( A ) = {E}_{{\hat{U}}^{z + 1}} ( {\underline{U}}_{mij}^{z + 1} ( A ) ) \\ = {E}_{{\hat{U}}^{z + 1}} ( {U}_{mim}^{z} {A}_{mj} {⋃}_{k = \{ 1 … n \} \backslash m} {U}_{mik}^{z} {A}_{kj} )\end{matrix} \qquad Equation 12$$

where E_{Û}_{^{z+1}}(x) is the operator that encodes the string x according to the codebook Û^{z+1}.

Continuing with the earlier example of computing U₋₁₂₃¹(A), where A=C₅, here is the codebook Û¹ for the z=1 time step of U(A):

$${\hat{U}}^{1}$$

$$1 : 0000001011$$

$$2 : 0000011010$$

$$3 : 0100001010$$

$$4 : 1000000011$$

$$5 : 1000000110$$

$$6 : 1100000010$$

Inspecting this list, it is apparent that the message computed earlier, 1000000110, will be recoded as the hexadecimal digit 5.

The recoding operation should have no effect from the point of view of algorithm correctness, since it preserves distinguishability of strings: any pair of strings that is distinguishable before recoding will be mapped to a pair of shorter code words that is also distinct. While recoding does not affect algorithm correctness, the operation is significant from a computational complexity perspective, since it ensures that the size of the strings remains polynomial in the problem size. Observe that the deck U has n³ entries, and the codebook for each time step can therefore be no larger than n³ entries. Thus the maximum message size after recording is log₂n³=3 log₂n bits, for any number of time steps. Although the maximum size of the codebook is known a priori, the actual required codebook size for any graph and time step is not known until the list of used code words has actually been computed. The recoding operator of an embodiment of the present invention outputs fixed length strings to ensure that the code is uniquely decodable. The output string size is determined by the size of the codebook. The strings must be long enough to label the last entry in the codebook.

In another embodiment, it may be desirable to use an appropriately chosen hash function instead of a codebook. One benefit of using a hash instead of a codebook is that the codebook does not need to be stored. The size of the hash would be determined by the expected size of the codebook. A disadvantage of using a hash instead of a codebook is that collisions are possible, which the codebook method avoids entirely.

Another embodiment is to use a codebook, but use hash keys to improve performance. This technique would not have a risk of incorrect results due to hash collisions, yet can speed operations such as insertions of new code words into the codebook.

At block 708, a check is made as to whether to continue processing of blocks 702, 704, and 706 for another iteration. In one embodiment, a second iteration is used to produce a message deck at iteration two and an associated codebook at iteration two. In other embodiments, additional iterations may be used. If another iteration is needed, processing continues again with block 702. Otherwise, processing continues with block 710.

At block 710, the final message deck, denoted U with no subscript, is formed by concatenating the message decks generated at time steps 1 and 2 element by element (i.e., elementwise):

$${U}_{mij} ( A ) = {U}_{mij}^{1} {U}_{mij}^{2} \qquad Equation 13$$

In another embodiment, additional message decks generated during additional iterations may also be concatenated for the final message deck. In the examples below the z=0 (time step zero) term is also included for increased clarity, although this is not necessary. The examples will show Uₘᵢⱼ(A)=Uₘᵢⱼ⁰Uₘᵢⱼ¹Uₘᵢⱼ². Continuing with the cycle graph example, here is card 1 from the deck U(A) where A=C₅. The first digit of an element is determined by the initialization. The second digit of an element is the message resulting from recoding after the first time step. The third digit of an element is the output of the recoding procedure for the second time step. The subscript 1 after the U below indicates the card number (m value). All values of i and j are listed.

$${U}_{1} ( A ) , A = {C}_{5}$$

$$\begin{matrix}137 & 06 D & 06 D & 038 & 038 \\ 011 & 15 A & 059 & 012 & 023 \\ 011 & 059 & 15 A & 023 & 012 \\ 024 & 04 B & 05 C & 126 & 015 \\ 024 & 05 C & 04 B & 015 & 126\end{matrix}$$

The entry in row 2, column 3 is ‘059’. In the earlier example computation for a card element, the ‘5’ digit was computed in this message.

At block 712, the final message deck U is row sorted to form a row sorted message deck R. First, each row of received messages may be sorted into a modified lexicographic order, an operation called “row sorting.” The modification to ordinary lexicographic order means that some additional information may be preserved that is available, but will not interfere with the invariance. Specifically, “degenerate” messages with j=m will be placed in column 1 (rather than in their lexicographic position), and messages with j=i will be placed in column 2, as shown in equation 14. Another modification which may be used in an embodiment is reverse lexicographic order. The doubly degenerate message with j=m=i, will be placed in column 1, as shown in equation 15. Implicitly, the distinct entries Uₘᵢⱼ in a row of U can be concatenated into a single long string in lexicographic order, thus eliminating the j dependence. In practice, R may still be stored as a three dimensional array, but the third dimension will have no dependence on the initial labeling of the graph. That is why R has only two subscripts in equations 14 and 15.

$${R}_{mi} ( A ) = {U}_{mim} ( A ) {U}_{mii} ( A ) {⋃}_{j = \{ 1 , … , n \} \backslash \{ i , m \}} {U}_{mij} ( A ) ( for i \neq m ) \qquad Equation 14$$

$${R}_{mm} ( A ) = {U}_{mmm} ( A ) {⋃}_{j = \{ 1 , … , n \} \backslash m} {U}_{mmj} ( A ) ( i . e . i = m ) \qquad Equation 15$$

Continuing with the example, here is R₁(A) where A=C₅. The subscript 1 after the R indicates the card number (i.e., m value). All of the entries within each row have been sorted into modified lexicographic order, but the order of the rows has not been changed. Thus, the row value i still can be identified with a particular vertex i, but the column position can no longer be (straightforwardly) associated with a vertex j.

$${R}_{1} ( A ) , A = {C}_{5}$$

$$\begin{matrix}137 & 038 & 038 & 06 D & 06 D \\ 011 & 15 A & 012 & 023 & 059 \\ 011 & 15 A & 012 & 023 & 059 \\ 024 & 126 & 015 & 04 B & 05 C \\ 024 & 126 & 015 & 04 B & 05 C\end{matrix}$$

In this example, the degenerate cases with j=i (the diagonal, first digit 1) are placed in column 2. The j=m messages are placed in column 1, including the doubly degenerate j=m=i message.

The invariant can be defined directly in terms of the message deck U. At block 714, the rows of the row sorted message deck R may be sorted to form a table sorted message deck T. The entries on each card of the table sorted message deck T have been sorted, but the order in which the cards themselves appear has not been modified from the order in which they appear in U:

$${T}_{m} ( A ) = {R}_{mm} ( A ) {⋃}_{i = \{ 1 , … , n \} \backslash m} \{ {R}_{mi} ( A ) \} \qquad Equation 16$$

In one embodiment, to form T from R, each of the strings in a row of R may be concatenated together (so each row becomes a single long strong). The resulting one dimensional list of strings may be sorted, and then the output of the list sorting operation may be “un-concatenated” to reform a two dimensional card-type structure (i.e., T).

At block 716, the cards of the table sorted message deck T may be sorted to form the invariant V:

$$\begin{matrix}V ( A ) = {⋃}_{m = \{ 1 , … , n \}} \{ {T}_{m} ( A ) \} or & Equation 17 \\ \begin{matrix}V ( A ) = {⋃}_{m = \{ 1 , … , n \}} \{ ( {U}_{mim} {⋃}_{j = \{ 1 , … , n \} \backslash m} {U}_{mij} , \\ {⋃}_{i = \{ 1 , … , n \} \backslash m} \{ {U}_{mim} {U}_{mii} {⋃}_{j = \{ 1 , … , n \} \backslash \{ i , m \}} {U}_{mij} \} ) \}\end{matrix} & Equation 18\end{matrix}$$

To form V from T, all of the messages on a card may be concatenated in the sorted order produced earlier to make one very long string per card (which yields a one dimensional list where each entry in the list represents an entire card). The list may then be sorted, and then “un-concatenated.” In other embodiments, other ways to generate T and V may be used. The invariant V may then be used in invariant comparison processing or for other purposes.

The combination of the union and set braces in the expression for T is meant to indicate that the integrity of the row sets R is preserved, but the order of the row sets is not. Contrast this with the codebook, where the integrity of the row sets or cards is not preserved. The time z first order codebook is simply the set of all messages produced by the graph at time step z. Analogously, the union and set brace notation in the V expression is meant to indicate that the nesting structure of the multiset of messages is preserved (i.e., card and row integrity is maintained), but card order is not, and the order of rows on each card is not.

Note that all of the codebooks generated in the course of computing the invariant should be considered part of the invariant as well.

To continue with the example, here is V₁(A), A=C₅. The subscript of V refers to the card number within V. Note that this form of the invariant consists of n sorted cards, each with n²entries on them.

$${V}_{1} ( A ) , A = {C}_{5}$$

$$\begin{matrix}137 & 038 & 038 & 06 D & 06 D \\ 011 & 15 A & 012 & 023 & 059 \\ 011 & 15 A & 012 & 023 & 059 \\ 024 & 126 & 015 & 04 B & 05 C \\ 024 & 126 & 015 & 04 B & 05 C\end{matrix}$$

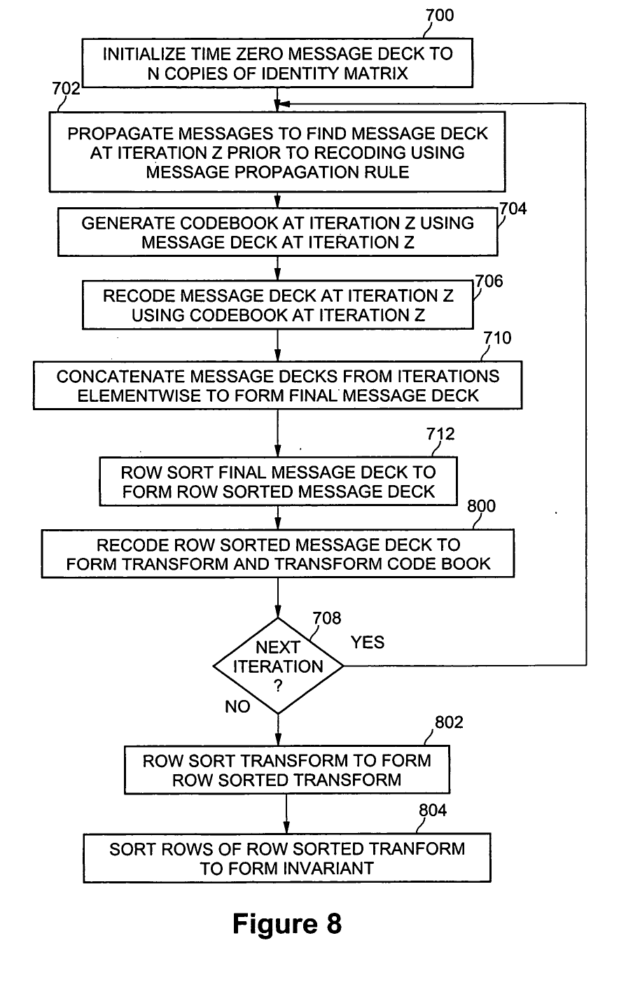

FIG. 8 is a flow diagram of invariant generation processing according to a second embodiment of the present invention. These steps may be performed based on a graph's adjacency matrix in order to generate the invariant values for the graph using the transform matrix S. This embodiment is also shown below in Table II.

TABLE II

| | |
|---|---|
| 1. | Initialize U⁰ matrix |
| 2. | Propagate to find U¹ |
| 3. | Recode to find U¹ and Û¹ |
| 4. | Propagate to find U² |
| 5. | Recode to find U² and Û² |
| 6. | Concatenate U¹ and U² elementwise to form U |
| 7. | Row sort U to form R |
| 8. | Recode R to find S and Ŝ |
| 9. | Row sort S to find S′ |
| 10. | Sort rows of S′ to find V′ |

Blocks 700-712 of FIG. 8 are similar to blocks 700-712 of FIG. 7. However, in FIG. 8, additional processing at blocks 800-804 may be performed, and the decision regarding iteration may be done at a different time. In this embodiment, as shown in FIG. 8, a second recoding operation may be performed at block 800. This second recoding operation operates on all the messages concatenated at all previous times z=1 to z=Z. The decision of whether to continue with additional iterations may be made based on the size of this second codebook. When this higher order codebook stops growing in size, it indicates that no further graph symmetries are being broken, and processing may stop. In this embodiment, a decision on whether to continue with a further iteration would occur after block 800 at decision block 708.

The invariant V′ can be defined in terms of the transform S. At block 800, the row sorted message deck R may be recoded to form transform matrix S and a codebook for S (denoted Ŝ). The codebook may be determined by:

$$\hat{S} = {⋃}_{m = 1}^{n} {⋃}_{i = 1}^{n} {R}_{mi} \qquad Equation 19$$

and the transform S may be computed by recoding R according to codebook Ŝ:
Sₘᵢ=E_{Ŝ}{Rₘᵢ} Equation 20
where the rows of the row sorted cards have been recoded by the recoding operator E_{Ŝ}. Note that prior to this recoding step, R may have been stored as a three-dimensional table, indexed by m,i, and j, but the order of the entries within each row no longer has any dependence on the initial graph labeling (because the entries within each row have been sorted into lexicographic order), which is why it is appropriate to suppress the j index even if R is still represented in memory as a three-dimensional table. If R is still represented by a three-dimensional table, then in one embodiment, the entries within each row (i.e. along the dimension of varying j) may be concatenated to form a single string. The end result is that what had been a three dimensional data table indexed by m,i, and j (with the entries along the j dimension sorted) becomes a two-dimensional table that may be indexed by m and i. The Rₘᵢ expressions in equations 19 and 20 can be interpreted as single strings in a two dimensional data structure of the sort just described.

In the example using C₅, transform S is:

$$S ( {C}_{5} )$$

$$\begin{matrix}3 & 1 & 1 & 2 & 2 \\ 1 & 3 & 2 & 1 & 2 \\ 1 & 2 & 3 & 2 & 1 \\ 2 & 1 & 2 & 3 & 1 \\ 2 & 2 & 1 & 1 & 3\end{matrix}$$

At block 708, a check is made as to whether to continue for another iteration. If so, processing continues with block 702. If not, processing continues with block 802. At block 802, the rows of the transform S may be sorted (within each row) to form a row sorted transform S′.

$${S}_{m}^{′} ( A ) = {S}_{mm} ( A ) {⋃}_{i = \{ 1 , … , n \} \backslash m} \{ {S}_{mi} ( A ) \}$$

At block 804, the invariant V′ may be defined in terms of the row sorted transform S′.

The invariant may be formed by sorting the rows of the row sorted transform. The alternate form V′ is given by:

$${V}^{′} ( A ) = {⋃}_{m = \{ 1 , … , n \}} \{ {S}_{m}^{′} ( A ) \} \qquad Equation 21$$

Here is V′(C₅). Note that this form of the invariant is just a single n×n table of numbers. It does not consist of multiple cards.

$${V}^{′} ( {C}_{5} )$$

$$\begin{matrix}3 & 1 & 1 & 2 & 2 \\ 3 & 1 & 1 & 2 & 2 \\ 3 & 1 & 1 & 2 & 2 \\ 3 & 1 & 1 & 2 & 2 \\ 3 & 1 & 1 & 2 & 2\end{matrix}$$

Herein is a complete sample graph C₅, with associated data structures according to an embodiment of the present invention. This graph consists of five nodes connected as a ring. It is a strongly regular graph (SRG) with parameters (n, k, λ, μ)=5,2,0,1. A number of graph properties are reflected in the transform. Since the graph is vertex transitive, all columns of the transform have the same elements, or equivalently, Vₘ is the same for all m. The graph is both edge transitive, and 1-path transitive, meaning that any edge can be mapped to any other edge, in either orientation. This is reflected in the transform, in which all edge entries (both “forward” and “backward,” e.g. all entries Sᵢₘ , and Sₘᵢ where nodes i and m are adjacent) are labeled in the same way. Because the complement of C₅ is also edge transitive, all the “non-edge entries” (excluding self edges) in the transform are coded in the same way. This explains why the transform S is symmetric (S=S^{T}). Note that this condition (graph and its complement are both 1-transitive) is not the most general that can produce a symmetric transform. In general all that is required is “1-path inversion symmetry,” wherein each edge (and complement-edge) can be mapped to an inverted version of itself; for a symmetric transform, it is not required that any edge (or complement edge) be mappable to any other than itself.

Also note that the absence of a symmetry in the transform proves the absence of that symmetry in the graph, but the presence of a symmetry in the transform does not necessarily prove the presence of that symmetry in the graph.

$$\vert {\hat{U}}^{z} \vert for z = \{ 0 , … , 9 \} : 0 \qquad 6 \qquad 13 \qquad 13 \qquad 13 \qquad 13 \qquad 13 \qquad 13 \qquad 13 \qquad 13$$

$$A = {C}_{5}$$

$$\begin{matrix}0 & 1 & 1 & 0 & 0 \\ 1 & 0 & 0 & 1 & 0 \\ 1 & 0 & 0 & 0 & 1 \\ 0 & 1 & 0 & 0 & 1 \\ 0 & 0 & 1 & 1 & 0\end{matrix}$$

$$S$$

$$\begin{matrix}3 & 1 & 1 & 2 & 2 \\ 1 & 3 & 2 & 1 & 2 \\ 1 & 2 & 3 & 2 & 1 \\ 2 & 1 & 2 & 3 & 1 \\ 2 & 2 & 1 & 1 & 3\end{matrix}$$

$${\hat{U}}^{1}$$

$$1 \text{:} 0000001011$$

$$2 \text{:} 0000011010$$

$$3 \text{:} 0100001010$$

$$4 \text{:} 1000000011$$

$$5 \text{:} 1000000110$$

$$6 \text{:} 1100000010$$

$${\hat{U}}^{2}$$

$$1 \text{:} 0101021515$$

$$2 \text{:} 0101051215$$

$$3 \text{:} 0102051115$$

$$4 \text{:} 0201021415$$

$$5 \text{:} 0201041215$$

$$6 \text{:} 0202051114$$

$$7 \text{:} 0303031616$$

$$8 \text{:} 0303061316$$

$$9 \text{:} 1101050512$$

$$A \text{:} 1102050511$$

$$B \text{:} 1201040512$$

$$C \text{:} 1202040511$$

$$D \text{:} 1303060613$$

$${U}_{{1}^{**}}$$

$$\begin{matrix}37 & 6 D & 6 D & 38 & 38 \\ 11 & 5 A & 59 & 12 & 23 \\ 11 & 59 & 5 A & 23 & 12 \\ 24 & 4 B & 5 C & 26 & 15 \\ 24 & 5 C & 4 B & 15 & 26\end{matrix}$$

$${U}_{{2}^{**}}$$

$$\begin{matrix}5 A & 11 & 12 & 59 & 23 \\ 6 D & 37 & 38 & 6 D & 38 \\ 4 B & 24 & 26 & 5 C & 15 \\ 59 & 11 & 23 & 5 A & 12 \\ 5 C & 24 & 15 & 4 B & 26\end{matrix}$$

$${U}_{{3}^{**}}$$

$$\begin{matrix}5 A & 12 & 11 & 23 & 59 \\ 4 B & 26 & 24 & 15 & 5 C \\ 6 D & 38 & 37 & 38 & 6 D \\ 5 C & 15 & 24 & 26 & 4 B \\ 59 & 23 & 11 & 12 & 5 A\end{matrix}$$

$${U}_{{4}^{**}}$$

$$\begin{matrix}26 & 4 B & 15 & 24 & 5 C \\ 12 & 5 A & 23 & 11 & 59 \\ 15 & 5 C & 26 & 24 & 4 B \\ 38 & 6 D & 38 & 37 & 6 D \\ 23 & 59 & 12 & 11 & 5 A\end{matrix}$$

$${U}_{{5}^{**}}$$

$$\begin{matrix}26 & 15 & 4 B & 5 C & 24 \\ 15 & 26 & 5 C & 4 B & 24 \\ 12 & 23 & 5 A & 59 & 11 \\ 23 & 12 & 59 & 5 A & 11 \\ 38 & 38 & 6 D & 6 D & 37\end{matrix}$$

$${R}_{{1}^{**}}$$

$$\begin{matrix}37 & 38 & 38 & 6 D & 6 D \\ 11 & 12 & 23 & 59 & 5 A \\ 11 & 12 & 23 & 59 & 5 A \\ 15 & 24 & 26 & 4 B & 5 C \\ 15 & 24 & 26 & 4 B & 5 C\end{matrix}$$

$${R}_{{2}^{**}}$$

$$\begin{matrix}11 & 12 & 23 & 59 & 5 A \\ 37 & 38 & 38 & 6 D & 6 D \\ 15 & 24 & 26 & 4 B & 5 C \\ 11 & 12 & 23 & 59 & 5 A \\ 15 & 24 & 26 & 4 B & 5 C\end{matrix}$$

$${V}_{1} … {V}_{5}$$

$$\begin{matrix}11 & 12 & 23 & 59 & 5 A \\ 11 & 12 & 23 & 59 & 5 A \\ 15 & 24 & 26 & 4 B & 5 C \\ 15 & 24 & 26 & 4 B & 5 C \\ 37 & 38 & 38 & 6 D & 6 D\end{matrix}$$

It will be readily apparent that the time required to compute the invariant is polynomial in the problem size. The size of U is n³. Each entry in U depends on n other entries, so the time required for propagation is O(n⁴), using “big O” notation familiar to those skilled in the art. There are at most n³ distinct messages in any propagation deck, so the size of the codebook is at most n³. Worst case sorting algorithms (such as bubble sort) require time proportional to n², and better methods such as a binary tree sort require time proportional to n log n. This means that the worst case time to generate the codebook would be (n³)²=n⁶ using bubblesort, or n³ log n³=3n³ log n using a binary tree sort. In the most naive implementation, the recoding operation itself would require on average O(n) comparisons for each of the n³ messages, for a complexity of O(n⁴). A binary-tree based implementation would require only log n lookups, for a complexity of O(n³ log n). The computational complexity is ordinarily defined by the largest exponent in the polynomial, so for reasonable implementations of the algorithm, the complexity of the algorithm is O(n⁴). A very naïve implementation would have complexity O(n⁶), but even this is unambiguously polynomial time.

In another embodiment, the following formula can be used to calculate the message deck U, instead of the explicit message propagation described earlier:

$${U}_{mij} = {U}_{mij}^{1} \vert {U}_{mij}^{2} \approx {δ}_{mi} {A}_{mj} {A}_{ij} \vert {δ}_{mi} {A}_{mi} {A}_{mj} {⋃}_{k = \{ 1 … n \} \backslash m} {A}_{mk} {A}_{ik} {A}_{jk}$$

This expression captures the minimal information guaranteed to be encoded in the messages generated by the ordinary propagation process after the trivial information has been discarded by recoding. It is possible that additional information is encoded in the messages generated by the ordinary propagation process, but at least this information must be encoded.

To derive another embodiment, observe that the z=1 message at node j is identical to the message that node j receives from itself at time z=2. Thus if the message propagation rule is modified so that the self-message is placed in a special position, it is no longer necessary to concatenate the z=1 and z=2 messages together. The z=2 message alone, computed in this alternate fashion, will suffice. Thus, the following update rule may be used, and no time series concatenation is required:

$${\underline{U}}_{mij}^{z + 1} ( A ) = {U}_{mim}^{z} {A}_{mj} {U}_{mii}^{z} {A}_{ij} {⋃}_{k = \{ 1 … n \} \backslash m \backslash i} {U}_{mik}^{2} {A}_{kj}$$

In another embodiment, the degenerate messages (i=j, i=m, i=j=m) are not placed in special positions when U is processed to form R, T, V, S, S′, or V′, but time series concatenation is used.

In another example, there are two strongly regular graphs with parameters 16-6-2-2. We call the two graphs 16-6-2-2-a, and 16-6-2-2-b. These graphs are known in the art as the Shrikhande graph, and L(K_{4,4}). This is the smallest pair of non-isomorphic strongly regular graphs with identical parameters. Below are listed two permutations of the adjacency matrix of 16-6-2-2-a, and two permutations of the adjacency matrix of 16-6-2-2-b, plus the transform of each. This is to illustrate how difficult it is to tell from the adjacency matrices alone whether the graphs are isomorphic or not, and how easy it is to make this determination from the transforms described herein.

$$\begin{matrix}A = Graph 16 - 6 - 2 - 2 - a ( permutation 1 ) \\ \begin{matrix}0 & 1 & 0 & 0 & 0 & 0 & 0 & 0 & 0 & 1 & 1 & 1 & 0 & 1 & 0 & 1 \\ 1 & 0 & 0 & 1 & 0 & 0 & 1 & 1 & 0 & 0 & 0 & 1 & 0 & 1 & 0 & 0 \\ 0 & 0 & 0 & 1 & 0 & 1 & 0 & 0 & 1 & 0 & 0 & 1 & 1 & 0 & 0 & 1 \\ 0 & 1 & 1 & 0 & 0 & 0 & 1 & 1 & 1 & 0 & 0 & 0 & 0 & 0 & 0 & 1 \\ 0 & 0 & 0 & 0 & 0 & 1 & 1 & 0 & 1 & 0 & 1 & 0 & 0 & 1 & 1 & 0 \\ 0 & 0 & 1 & 0 & 1 & 0 & 1 & 0 & 0 & 0 & 1 & 1 & 1 & 0 & 0 & 0 \\ 0 & 1 & 0 & 1 & 1 & 1 & 0 & 1 & 0 & 0 & 1 & 0 & 0 & 0 & 0 & 0 \\ 0 & 1 & 0 & 1 & 0 & 0 & 1 & 0 & 0 & 1 & 0 & 0 & 1 & 0 & 1 & 0 \\ 0 & 0 & 1 & 1 & 1 & 0 & 0 & 0 & 0 & 0 & 0 & 0 & 0 & 1 & 1 & 1 \\ 1 & 0 & 0 & 0 & 0 & 0 & 0 & 1 & 0 & 0 & 1 & 0 & 1 & 0 & 1 & 1 \\ 1 & 0 & 0 & 0 & 1 & 1 & 1 & 0 & 0 & 1 & 0 & 0 & 0 & 0 & 0 & 1 \\ 1 & 1 & 1 & 0 & 0 & 1 & 0 & 0 & 0 & 0 & 0 & 0 & 1 & 1 & 0 & 0 \\ 0 & 0 & 1 & 0 & 0 & 1 & 0 & 1 & 0 & 1 & 0 & 1 & 0 & 0 & 1 & 0 \\ 1 & 1 & 0 & 0 & 1 & 0 & 0 & 0 & 1 & 0 & 0 & 1 & 0 & 0 & 1 & 0 \\ 0 & 0 & 0 & 0 & 1 & 0 & 0 & 1 & 1 & 1 & 0 & 0 & 1 & 1 & 0 & 0 \\ 1 & 0 & 1 & 1 & 0 & 0 & 0 & 0 & 1 & 1 & 1 & 0 & 0 & 0 & 0 & 0\end{matrix}\end{matrix}$$

$$\begin{matrix}S ( A ) , A = Graph 16 - 6 - 2 - 2 - a ( permutation 1 ) \\ \begin{matrix}3 & 1 & 2 & 2 & 2 & 2 & 2 & 2 & 2 & 1 & 1 & 1 & 2 & 1 & 2 & 1 \\ 1 & 3 & 2 & 1 & 2 & 2 & 1 & 1 & 2 & 2 & 2 & 1 & 2 & 1 & 2 & 2 \\ 2 & 2 & 3 & 1 & 2 & 1 & 2 & 2 & 1 & 2 & 2 & 1 & 1 & 2 & 2 & 1 \\ 2 & 1 & 1 & 3 & 2 & 2 & 1 & 1 & 1 & 2 & 2 & 2 & 2 & 2 & 2 & 1 \\ 2 & 2 & 2 & 2 & 3 & 1 & 1 & 2 & 1 & 2 & 1 & 2 & 2 & 1 & 1 & 2 \\ 2 & 2 & 1 & 2 & 1 & 3 & 1 & 2 & 2 & 2 & 1 & 1 & 1 & 2 & 2 & 2 \\ 2 & 1 & 2 & 1 & 1 & 1 & 3 & 1 & 2 & 2 & 1 & 2 & 2 & 2 & 2 & 2 \\ 2 & 1 & 2 & 1 & 2 & 2 & 1 & 3 & 2 & 1 & 2 & 2 & 1 & 2 & 1 & 2 \\ 2 & 2 & 1 & 1 & 1 & 2 & 2 & 2 & 3 & 2 & 2 & 2 & 2 & 1 & 1 & 1 \\ 1 & 2 & 2 & 2 & 2 & 2 & 2 & 1 & 2 & 3 & 1 & 2 & 1 & 2 & 1 & 1 \\ 1 & 2 & 2 & 2 & 1 & 1 & 1 & 2 & 2 & 1 & 3 & 2 & 2 & 2 & 2 & 1 \\ 1 & 1 & 1 & 2 & 2 & 1 & 2 & 2 & 2 & 2 & 2 & 3 & 1 & 1 & 2 & 2 \\ 2 & 2 & 1 & 2 & 2 & 1 & 2 & 1 & 2 & 1 & 2 & 1 & 3 & 2 & 1 & 2 \\ 1 & 1 & 2 & 2 & 1 & 2 & 2 & 2 & 1 & 2 & 2 & 1 & 2 & 3 & 1 & 2 \\ 2 & 2 & 2 & 2 & 1 & 2 & 2 & 1 & 1 & 1 & 2 & 2 & 1 & 1 & 3 & 2 \\ 1 & 2 & 1 & 1 & 2 & 2 & 2 & 2 & 1 & 1 & 1 & 2 & 2 & 2 & 2 & 3\end{matrix}\end{matrix}$$

$$\begin{matrix}A = Graph 16 - 6 - 2 - 2 - a ( permutation 2 ) \\ \begin{matrix}0 & 0 & 0 & 0 & 0 & 1 & 0 & 1 & 1 & 1 & 1 & 1 & 0 & 0 & 0 & 0 \\ 0 & 0 & 0 & 1 & 1 & 0 & 0 & 0 & 1 & 0 & 1 & 0 & 1 & 0 & 1 & 0 \\ 0 & 0 & 0 & 0 & 1 & 1 & 1 & 0 & 0 & 1 & 0 & 0 & 1 & 1 & 0 & 0 \\ 0 & 1 & 0 & 0 & 1 & 0 & 0 & 1 & 0 & 0 & 1 & 0 & 0 & 1 & 0 & 1 \\ 0 & 1 & 1 & 1 & 0 & 1 & 1 & 0 & 0 & 0 & 1 & 0 & 0 & 0 & 0 & 0 \\ 1 & 0 & 1 & 0 & 1 & 0 & 1 & 1 & 1 & 0 & 0 & 0 & 0 & 0 & 0 & 0 \\ 0 & 0 & 1 & 0 & 1 & 1 & 0 & 0 & 0 & 0 & 0 & 1 & 0 & 0 & 1 & 1 \\ 1 & 0 & 0 & 1 & 0 & 1 & 0 & 0 & 1 & 0 & 0 & 0 & 0 & 1 & 0 & 1 \\ 1 & 1 & 0 & 0 & 0 & 1 & 0 & 1 & 0 & 0 & 0 & 0 & 1 & 0 & 1 & 0 \\ 1 & 0 & 1 & 0 & 0 & 0 & 0 & 0 & 0 & 0 & 1 & 1 & 1 & 1 & 0 & 0 \\ 1 & 1 & 0 & 1 & 1 & 0 & 0 & 0 & 0 & 1 & 0 & 1 & 0 & 0 & 0 & 0 \\ 1 & 0 & 0 & 0 & 0 & 0 & 1 & 0 & 0 & 1 & 1 & 0 & 0 & 0 & 1 & 1 \\ 0 & 1 & 1 & 0 & 0 & 0 & 0 & 0 & 1 & 1 & 0 & 0 & 0 & 1 & 1 & 0 \\ 0 & 0 & 1 & 1 & 0 & 0 & 0 & 1 & 0 & 1 & 0 & 0 & 1 & 0 & 0 & 1 \\ 0 & 1 & 0 & 0 & 0 & 0 & 1 & 0 & 1 & 0 & 0 & 1 & 1 & 0 & 0 & 1 \\ 0 & 0 & 0 & 1 & 0 & 0 & 1 & 1 & 0 & 0 & 0 & 1 & 0 & 1 & 1 & 0\end{matrix}\end{matrix}$$

$$\begin{matrix}S ( A ) , A = Graph 16 - 6 - 2 - 2 - a ( permutation 2 ) \\ \begin{matrix}3 & 2 & 2 & 2 & 2 & 1 & 2 & 1 & 1 & 1 & 1 & 1 & 2 & 2 & 2 & 2 \\ 2 & 3 & 2 & 1 & 1 & 2 & 2 & 2 & 1 & 2 & 1 & 2 & 1 & 2 & 1 & 2 \\ 2 & 2 & 3 & 2 & 1 & 1 & 1 & 2 & 2 & 1 & 2 & 2 & 1 & 1 & 2 & 2 \\ 2 & 1 & 2 & 3 & 1 & 2 & 2 & 1 & 2 & 2 & 1 & 2 & 2 & 1 & 2 & 1 \\ 2 & 1 & 1 & 1 & 3 & 1 & 1 & 2 & 2 & 2 & 1 & 2 & 2 & 2 & 2 & 2 \\ 1 & 2 & 1 & 2 & 1 & 3 & 1 & 1 & 1 & 2 & 2 & 2 & 2 & 2 & 2 & 2 \\ 2 & 2 & 1 & 2 & 1 & 1 & 3 & 2 & 2 & 2 & 2 & 1 & 2 & 2 & 1 & 1 \\ 1 & 2 & 2 & 1 & 2 & 1 & 2 & 3 & 1 & 2 & 2 & 2 & 2 & 1 & 2 & 1 \\ 1 & 1 & 2 & 2 & 2 & 1 & 2 & 1 & 3 & 2 & 2 & 2 & 1 & 2 & 1 & 2 \\ 1 & 2 & 1 & 2 & 2 & 2 & 2 & 2 & 2 & 3 & 1 & 1 & 1 & 1 & 2 & 2 \\ 1 & 1 & 2 & 1 & 1 & 2 & 2 & 2 & 2 & 1 & 3 & 1 & 2 & 2 & 2 & 2 \\ 1 & 2 & 2 & 2 & 2 & 2 & 1 & 2 & 2 & 1 & 1 & 3 & 2 & 2 & 1 & 1 \\ 2 & 1 & 1 & 2 & 2 & 2 & 2 & 2 & 1 & 1 & 2 & 2 & 3 & 1 & 1 & 2 \\ 2 & 2 & 1 & 1 & 2 & 2 & 2 & 1 & 2 & 1 & 2 & 2 & 1 & 3 & 2 & 1 \\ 2 & 1 & 2 & 2 & 2 & 2 & 1 & 2 & 1 & 2 & 2 & 1 & 1 & 2 & 3 & 1 \\ 2 & 2 & 2 & 1 & 2 & 2 & 1 & 1 & 2 & 2 & 2 & 1 & 2 & 1 & 1 & 3\end{matrix}\end{matrix}$$

$$\begin{matrix}A = Graph 16 - 6 - 2 - 2 - b ( permutation 1 ) \\ \begin{matrix}0 & 0 & 1 & 0 & 1 & 0 & 0 & 0 & 0 & 1 & 1 & 1 & 0 & 0 & 0 & 1 \\ 0 & 0 & 0 & 1 & 1 & 0 & 0 & 0 & 1 & 0 & 0 & 0 & 1 & 1 & 0 & 1 \\ 1 & 0 & 0 & 0 & 0 & 0 & 1 & 1 & 0 & 1 & 0 & 0 & 1 & 0 & 0 & 1 \\ 0 & 1 & 0 & 0 & 1 & 1 & 0 & 0 & 0 & 1 & 0 & 0 & 1 & 0 & 1 & 0 \\ 1 & 1 & 0 & 1 & 0 & 0 & 0 & 0 & 0 & 0 & 0 & 1 & 0 & 0 & 1 & 1 \\ 0 & 0 & 0 & 1 & 0 & 0 & 1 & 0 & 1 & 1 & 1 & 0 & 0 & 0 & 1 & 0 \\ 0 & 0 & 1 & 0 & 0 & 1 & 0 & 1 & 1 & 0 & 0 & 0 & 0 & 0 & 1 & 1 \\ 0 & 0 & 1 & 0 & 0 & 0 & 1 & 0 & 0 & 0 & 0 & 1 & 1 & 1 & 1 & 0 \\ 0 & 1 & 0 & 0 & 0 & 1 & 1 & 0 & 0 & 0 & 1 & 0 & 0 & 1 & 0 & 1 \\ 1 & 0 & 1 & 1 & 0 & 1 & 0 & 0 & 0 & 0 & 1 & 0 & 1 & 0 & 0 & 0 \\ 1 & 0 & 0 & 0 & 0 & 1 & 0 & 0 & 1 & 1 & 0 & 1 & 0 & 1 & 0 & 0 \\ 1 & 0 & 0 & 0 & 1 & 0 & 0 & 1 & 0 & 0 & 1 & 0 & 0 & 1 & 1 & 0 \\ 0 & 1 & 1 & 1 & 0 & 0 & 0 & 1 & 0 & 1 & 0 & 0 & 0 & 1 & 0 & 0 \\ 0 & 1 & 0 & 0 & 0 & 0 & 0 & 1 & 1 & 0 & 1 & 1 & 1 & 0 & 0 & 0 \\ 0 & 0 & 0 & 1 & 1 & 1 & 1 & 1 & 0 & 0 & 0 & 1 & 0 & 0 & 0 & 0 \\ 1 & 1 & 1 & 0 & 1 & 0 & 1 & 0 & 1 & 0 & 0 & 0 & 0 & 0 & 0 & 0\end{matrix}\end{matrix}$$

$$\begin{matrix}S ( A ) , A = Graph 16 - 6 - 2 - 2 - b ( permutation 1 ) \\ \begin{matrix}4 & 3 & 1 & 2 & 1 & 3 & 3 & 2 & 2 & 1 & 1 & 1 & 3 & 3 & 3 & 1 \\ 3 & 4 & 2 & 1 & 1 & 2 & 3 & 3 & 1 & 3 & 3 & 2 & 1 & 1 & 3 & 1 \\ 1 & 2 & 4 & 3 & 3 & 2 & 1 & 1 & 3 & 1 & 3 & 2 & 1 & 3 & 3 & 1 \\ 2 & 1 & 3 & 4 & 1 & 1 & 3 & 2 & 2 & 1 & 3 & 3 & 1 & 3 & 1 & 3 \\ 1 & 1 & 3 & 1 & 4 & 3 & 2 & 3 & 3 & 2 & 3 & 1 & 3 & 2 & 1 & 1 \\ 3 & 2 & 2 & 1 & 3 & 4 & 1 & 3 & 1 & 1 & 1 & 2 & 3 & 3 & 1 & 3 \\ 3 & 3 & 1 & 3 & 2 & 1 & 4 & 1 & 1 & 2 & 3 & 3 & 3 & 2 & 1 & 1 \\ 2 & 3 & 1 & 2 & 3 & 3 & 1 & 4 & 2 & 3 & 3 & 1 & 1 & 1 & 1 & 3 \\ 2 & 1 & 3 & 2 & 3 & 1 & 1 & 2 & 4 & 3 & 1 & 3 & 3 & 1 & 3 & 1 \\ 1 & 3 & 1 & 1 & 2 & 1 & 2 & 3 & 3 & 4 & 1 & 3 & 1 & 2 & 3 & 3 \\ 1 & 3 & 3 & 3 & 3 & 1 & 3 & 3 & 1 & 1 & 4 & 1 & 2 & 1 & 2 & 2 \\ 1 & 2 & 2 & 3 & 1 & 2 & 3 & 1 & 3 & 3 & 1 & 4 & 3 & 1 & 1 & 3 \\ 3 & 1 & 1 & 1 & 3 & 3 & 3 & 1 & 3 & 1 & 2 & 3 & 4 & 1 & 2 & 2 \\ 3 & 1 & 3 & 3 & 2 & 3 & 2 & 1 & 1 & 2 & 1 & 1 & 1 & 4 & 3 & 3 \\ 3 & 3 & 3 & 1 & 1 & 1 & 1 & 1 & 3 & 3 & 2 & 1 & 2 & 3 & 4 & 2 \\ 1 & 1 & 1 & 3 & 1 & 3 & 1 & 3 & 1 & 3 & 2 & 3 & 2 & 3 & 2 & 4\end{matrix}\end{matrix}$$

$$\begin{matrix}A = Graph 16 - 6 - 2 - 2 - b ( permutation 2 ) \\ \begin{matrix}0 & 1 & 0 & 0 & 1 & 0 & 0 & 1 & 0 & 0 & 1 & 1 & 0 & 1 & 0 & 0 \\ 1 & 0 & 0 & 0 & 0 & 0 & 0 & 0 & 1 & 0 & 0 & 1 & 0 & 1 & 1 & 1 \\ 0 & 0 & 0 & 0 & 0 & 0 & 0 & 1 & 1 & 1 & 1 & 0 & 1 & 0 & 1 & 0 \\ 0 & 0 & 0 & 0 & 1 & 1 & 1 & 0 & 1 & 0 & 1 & 0 & 0 & 0 & 0 & 1 \\ 1 & 0 & 0 & 1 & 0 & 1 & 0 & 0 & 0 & 1 & 1 & 1 & 0 & 0 & 0 & 0 \\ 0 & 0 & 0 & 1 & 1 & 0 & 1 & 0 & 0 & 1 & 0 & 0 & 0 & 1 & 1 & 0 \\ 0 & 0 & 0 & 1 & 0 & 1 & 0 & 1 & 0 & 0 & 0 & 0 & 1 & 1 & 0 & 1 \\ 1 & 0 & 1 & 0 & 0 & 0 & 1 & 0 & 0 & 0 & 1 & 0 & 1 & 1 & 0 & 0 \\ 0 & 1 & 1 & 1 & 0 & 0 & 0 & 0 & 0 & 0 & 1 & 0 & 0 & 0 & 1 & 1 \\ 0 & 0 & 1 & 0 & 1 & 1 & 0 & 0 & 0 & 0 & 0 & 1 & 1 & 0 & 1 & 0 \\ 1 & 0 & 1 & 1 & 1 & 0 & 0 & 1 & 1 & 0 & 0 & 0 & 0 & 0 & 0 & 0 \\ 1 & 1 & 0 & 0 & 1 & 0 & 0 & 0 & 0 & 1 & 0 & 0 & 1 & 0 & 0 & 1 \\ 0 & 0 & 1 & 0 & 0 & 0 & 1 & 1 & 0 & 1 & 0 & 1 & 0 & 0 & 0 & 1 \\ 1 & 1 & 0 & 0 & 0 & 1 & 1 & 1 & 0 & 0 & 0 & 0 & 0 & 0 & 1 & 0 \\ 0 & 1 & 1 & 0 & 0 & 1 & 0 & 0 & 1 & 1 & 0 & 0 & 0 & 1 & 0 & 0 \\ 0 & 1 & 0 & 1 & 0 & 0 & 1 & 0 & 1 & 0 & 0 & 1 & 1 & 0 & 0 & 0\end{matrix}\end{matrix}$$

$$\begin{matrix}S ( A ) , A = Graph 16 - 6 - 2 - 2 - b ( permutation 2 ) \\ \begin{matrix}4 & 1 & 3 & 3 & 1 & 2 & 3 & 1 & 2 & 3 & 1 & 1 & 2 & 1 & 3 & 3 \\ 1 & 4 & 3 & 3 & 3 & 3 & 2 & 3 & 1 & 2 & 2 & 1 & 3 & 1 & 1 & 1 \\ 3 & 3 & 4 & 3 & 2 & 3 & 3 & 1 & 1 & 1 & 1 & 3 & 1 & 2 & 1 & 2 \\ 3 & 3 & 3 & 4 & 1 & 1 & 1 & 2 & 1 & 3 & 1 & 2 & 3 & 3 & 2 & 1 \\ 1 & 3 & 2 & 1 & 4 & 1 & 3 & 3 & 3 & 1 & 1 & 1 & 3 & 2 & 3 & 2 \\ 2 & 3 & 3 & 1 & 1 & 4 & 1 & 3 & 2 & 1 & 3 & 3 & 2 & 1 & 1 & 3 \\ 3 & 2 & 3 & 1 & 3 & 1 & 4 & 1 & 3 & 2 & 2 & 3 & 1 & 1 & 3 & 1 \\ 1 & 3 & 1 & 2 & 3 & 3 & 1 & 4 & 3 & 3 & 1 & 2 & 1 & 1 & 2 & 3 \\ 2 & 1 & 1 & 1 & 3 & 2 & 3 & 3 & 4 & 3 & 1 & 3 & 2 & 3 & 1 & 1 \\ 3 & 2 & 1 & 3 & 1 & 1 & 2 & 3 & 3 & 4 & 2 & 1 & 1 & 3 & 1 & 3 \\ 1 & 2 & 1 & 1 & 1 & 3 & 2 & 1 & 1 & 2 & 4 & 3 & 3 & 3 & 3 & 3 \\ 1 & 1 & 3 & 2 & 1 & 3 & 3 & 2 & 3 & 1 & 3 & 4 & 1 & 3 & 2 & 1 \\ 2 & 3 & 1 & 3 & 3 & 2 & 1 & 1 & 2 & 1 & 3 & 1 & 4 & 3 & 3 & 1 \\ 1 & 1 & 2 & 3 & 2 & 1 & 1 & 1 & 3 & 3 & 3 & 3 & 3 & 4 & 1 & 2 \\ 3 & 1 & 1 & 2 & 3 & 1 & 3 & 2 & 1 & 1 & 3 & 2 & 3 & 1 & 4 & 3 \\ 3 & 1 & 2 & 1 & 2 & 3 & 1 & 3 & 1 & 3 & 3 & 1 & 1 & 2 & 3 & 4\end{matrix}\end{matrix}$$

Although the operations described herein may be described as a sequential process, some of the operations may in fact be performed in parallel or concurrently. In addition, in some embodiments the order of the operations may be rearranged.

The techniques described herein are not limited to any particular hardware, firmware, or software configuration; they may find applicability in any computing or processing environment. The techniques may be implemented in hardware, firmware, software, or any combination of these technologies. The techniques may be implemented in programs executing on programmable machines such as mobile or stationary computers, personal digital assistants, set top boxes, cellular telephones and pagers, and other electronic devices, that each include a processor, a storage medium readable by the processor (including volatile and non-volatile memory and/or storage elements), at least one input device, and one or more output devices. Program code is applied to the data entered using the input device to perform the functions described and to generate output information. The output information may be applied to one or more output devices. One of ordinary skill in the art may appreciate that the invention can be practiced with various computer system configurations, including multiprocessor systems, minicomputers, mainframe computers, and the like. The invention can also be practiced in distributed computing environments where tasks may be performed by remote processing devices that are linked through a communications network.

Each program may be implemented in a high level procedural or object oriented programming language to communicate with a processing system. However, programs may be implemented in assembly or machine language, if desired. In any case, the language may be compiled or interpreted.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as a computer program product that may include a machine accessible medium having stored thereon instructions that may be used to program a processing system or other electronic device to perform the methods. The term “machine accessible medium” used herein shall include any medium that is capable of storing or encoding a sequence of instructions for execution by a machine and that cause the machine to perform any one of the methods described herein. The term “machine accessible medium” shall accordingly include, but not be limited to, solid-state memories, optical and magnetic disks, and a carrier wave that encodes a data signal. Furthermore, it is common in the art to speak of software, in one form or another (e.g., program, procedure, process, application, module, logic, and so on) as taking an action or causing a result. Such expressions are merely a shorthand way of stating the execution of the software by a processing system cause the processor to perform an action of produce a result.

What is claimed is:

1. A computer-implemented method of generating a complete invariant for a graph comprising:
initializing each card of an initial message deck to an identity matrix;
propagating messages to form a first iteration message deck using a message propagation rule;
generating a first iteration codebook using the first iteration message deck;
recoding the first iteration message deck using the first iteration codebook;
repeating the propagating, generating, and recoding steps for at least a second iteration;
concatenating the message decks elementwise to form a final message deck;
row sorting the final message deck to form a row sorted message deck;
sorting rows of the row sorted message deck to form a table sorted message deck; and
sorting cards of the table sorted message deck to form the invariant.

2. The computer-implemented method of claim 1, wherein each message deck comprises an array of cards, each card comprises a two dimensional array of strings, the invariant comprises a three dimensional array of strings, and the length of each array comprises the number of vertices in the graph.

3. The computer-implemented method of claim 1, wherein the message propagation rule used to form the first iteration message deck uses an adjacency matrix corresponding to the graph.

4. The computer-implemented method of claim 3, wherein the message propagation rule is:
$${\underline{U}}_{mij}^{z + 1} ( A ) = ( ( {U}_{mim}^{z} , {A}_{mj} ) , {⋃}_{k = \{ 1 … n \} \backslash m} \{ ( {U}_{mik}^{z} , {A}_{kj} ) \} )$$
where U^{z} is the message deck at iteration z, A is the adjacency matrix, n is the number of vertices in the graph, and m, i, and j are indices of the three dimensions of the message deck.

5. The computer-implemented method of claim 1, wherein generating a codebook comprises computing:
$${\hat{U}}^{z} = {⋃}_{m = 1}^{n} {⋃}_{i = 1}^{n} {⋃}_{j = 1}^{n} {\underline{U}}_{mij}^{z}$$
where Û^{z} is the codebook at iteration z, n is the number of vertices in the graph, and m, i, and j are indices of the three dimensions of the message deck at iteration z.

6. The computer-implemented method of claim 1, wherein row sorting the final message deck comprises computing:
$${R}_{mi} ( A ) = {U}_{mim} ( A ) {U}_{mii} ( A ) {⋃}_{j = \{ 1 , … , n \} \backslash \{ i , m \}} {U}_{mij} ( A ) ( for i \neq m )$$
$${R}_{mm} ( A ) = {U}_{mmm} ( A ) {⋃}_{j = \{ 1 , … , n \} \backslash m} {U}_{mmj} ( A ) ( i . e . i = m )$$
where R is the row sorted message deck, U is the final message deck, A is the adjacency matrix for the graph, n is the number of vertices in the graph, and m, i, and j are indices of the three dimensions of the final message deck.

7. The computer-implemented method of claim 1, wherein sorting rows of the row sorted message deck comprises computing:
$${T}_{m} ( A ) = {R}_{mm} ( A ) {⋃}_{i = \{ 1 , … , n \} \backslash m} \{ {R}_{mi} ( A ) \}$$
where T is the table sorted message deck, R is the row sorted message deck, A is the adjacency matrix for the graph, n is the number of vertices in the graph, and m and i are indices of two of the dimensions of the row sorted message deck.

8. The computer-implemented method of claim 1, wherein sorting cards of the table sorted message deck comprises computing:
$$V ( A ) = {⋃}_{m = \{ 1 , … , n \}} \{ {T}_{m} ( A ) \}$$
where V is the invariant, A is the adjacency matrix for the graph, T is the table sorted message deck, n is the number of vertices in the graph, and m is an index of the cards of the table sorted message deck.

9. The computer-implemented method of claim 3, further comprising storing the invariant and the adjacency matrix in as an ordered pair.

10. An article comprising: a machine accessible medium containing instructions; which when executed, result in generating a complete invariant for a graph by
initializing each card of an initial message deck to an identity matrix;
propagating messages to form a first iteration message deck using a message propagation rule;
generating a first iteration codebook using the first iteration message deck;
recoding the first iteration message deck using the first iteration codebook;
repeating the propagating, generating, and recoding steps for at least a second iteration;
concatenating the message decks elementwise to form a final message deck;
row sorting the final message deck to form a row sorted message deck;
sorting rows of the row sorted message deck to form a table sorted message deck; and
sorting cards of the table sorted message deck to form the invariant.

11. The article of claim 10, wherein each message deck comprises an array of cards, each card comprises a two dimensional array of strings, the invariant comprises a three dimensional array of strings, and the length of each array comprises the number of vertices in the graph.

12. The article of claim 10, wherein the message propagation rule used to form the first iteration message deck uses an adjacency matrix corresponding to the graph.

13. The article of claim 12, wherein the message propagation rule is:
$${\underline{U}}_{mij}^{z + 1} ( A ) = ( ( {U}_{mim}^{z} , {A}_{mj} ) , {⋃}_{k = \{ 1 … n \} \backslash m } \{ ( {U}_{mik}^{z} , {A}_{kj} ) \} )$$
where U^{z} is the message deck at iteration z, A is the adjacency matrix, n is the number of vertices in the graph, and m, i, and j are indices of the three dimensions of the message deck.

14. The article of claim 10, wherein instructions to generate a codebook comprise instructions to compute:
$${\hat{U}}^{z} = {⋃}_{m = 1}^{n} {⋃}_{i = 1}^{n} {⋃}_{j = 1}^{n} {\underline{U}}_{mij}^{z}$$
where Û^{z} is the codebook at iteration z, n is the number of vertices in the graph, and m, i, and j are indices of the three dimensions of the message deck at iteration z.

15. The article of claim 10, wherein instructions to row sort the final message deck comprise instructions to compute:
$${R}_{mi} ( A ) = {U}_{mim} ( A ) {U}_{mii} ( A ) {⋃}_{j = \{ 1 , … , n \} \backslash \{ i , m \}} {U}_{mij} ( A ) ( for i \neq m )$$
$${R}_{mm} ( A ) = {U}_{mmm} ( A ) {⋃}_{j = \{ 1 , … , n \} \backslash m} {U}_{mmj} ( A ) ( i . e . i = m )$$
where R is the row sorted message deck, U is the final message deck, A is the adjacency matrix for the graph, n is the number of vertices in the graph, and m, i, and j are indices of the three dimensions of the final message deck.

16. The article of claim 10, wherein instructions to sort rows of the row sorted message deck comprise instructions to compute:
$${T}_{m} ( A ) = {R}_{mm} ( A ) {⋃}_{j = \{ 1 , … , n \} \backslash m} \{ {R}_{mi} ( A ) \}$$
where T is the table sorted message deck, R is the row sorted message deck, A is the adjacency matrix for the graph, n is the number of vertices in the graph, and m and i are indices of two of the dimensions of the row sorted message deck.

17. The article of claim 10, wherein instructions to sort cards of the table sorted message deck comprise instructions to compute:
$$V ( A ) = {⋃}_{m = \{ 1 , … , n \}} \{ {T}_{m} ( A ) \}$$
where V is the invariant, A is the adjacency matrix for the graph, T is the table sorted message deck, n is the number of vertices in the graph, and m is an index of the cards of the table sorted message deck.

18. A system for testing isomorphism of two graphs comprising:
an invariant generation module to accept an adjacency matrix for each graph and produce an invariant for each graph; and
an invariant comparison module coupled to the invariant generation module to accept the invariants, to compare the invariants, and to produce an isomorphism indicator;
wherein the invariant generation module is adapted to perform the following for each graph
initialize each card of an initial message deck to an identity matrix;
propagate messages to form a first iteration message deck using a message propagation rule;
generate a first iteration codebook using the first iteration message deck;
recode the first iteration message deck using the first iteration codebook;
repeat the propagating, generating, and recoding steps for at least a second iteration;
concatenate the message decks elementwise to form a final message deck;
row sort the final message deck to form a row sorted message deck;
sort rows of the row sorted message deck to form a table sorted message deck; and
sort cards of the table sorted message deck to form the invariant for the graph.

19. The system of claim 18, wherein each message deck comprises an array of cards, each card comprises a two dimensional array of strings, the invariant comprises a three dimensional array of strings, and the length of each array comprises the number of vertices in the graph.

20. The system of claim 18, wherein the message propagation rule used to form the first iteration message deck uses an adjacency matrix corresponding to the graph.

21. The system of claim 20, wherein the message propagation rule is:
$${\underline{U}}_{mij}^{z + 1} ( A ) = ( ( {U}_{mim}^{z} , {A}_{mj} ) , {⋃}_{k = \{ 1 … n \} \backslash m } \{ ( {U}_{mik}^{z} , {A}_{kj} ) \} )$$
where U^{z} is the message deck at iteration z, A is the adjacency matrix, n is the number of vertices in the graph, and m, i, and j are indices of the three dimensions of the message deck.

22. A computer-implemented method of generating a complete invariant for a graph comprising:
initializing each card of an initial message deck to an identity matrix;
propagating messages to form a first iteration message deck using a message propagation rule;
generating a first iteration codebook using the first iteration message deck;
recoding the first iteration message deck using the first iteration codebook;
repeating the propagating, generating, and recoding steps for at least a second iteration;
concatenating the message decks elementwise to form a final message deck;
row sorting the final message deck to form a row sorted message deck;
recoding the row sorted message deck to form a transform and a transform codebook;
row sorting the transform to form a row sorted transform; and
sorting rows of the row sorted transform to form the invariant.

23. The computer-implemented method of claim 22, wherein forming the transform codebook comprises computing:
$$\hat{S} = {⋃}_{m = 1}^{n} {⋃}_{i = 1}^{n} {R}_{mi}$$
where Ŝ is the transform codebook, R is the row sorted message deck, n is the number of vertices in the graph, and m and i are indices of two of the dimensions of the row sorted message deck.

24. The computer-implemented method of claim 22, wherein forming the transform comprises computing:
Sₘᵢ=E_{Ŝ}{Rₘᵢ}
where S is the transform, S is the transform codebook, and E is a recoding operator that recodes R according to codebook Ŝ.

25. The computer-implemented method of claim 22, wherein sorting the rows of the row sorted transform comprises computing:
$${V}^{′} ( A ) = {⋃}_{m = \{ 1 , … , n \}} \{ {S}_{mm} ( A ) {⋃}_{i = \{ 1 , … , n \} \backslash m } \{ {S}_{mi} ( A ) \} \}$$
where V′ is the invariant, A is the adjacency matrix for the graph, S is the transform, n is the number of vertices in the graph, and m and i are indices of two of the dimensions of the transform.

26. The computer-implemented method of claim 25, further comprising storing the invariant and the adjacency matrix as an ordered pair.

27. The computer-implemented method of claim 22, further comprising storing the invariant and the transform as an ordered pair.

28. An article comprising: a machine accessible medium containing instructions, which when executed, result in generating a complete invariant for a graph by
initializing each card of an initial message deck to an identity matrix;
propagating messages to form a first iteration message deck using a message propagation rule;
generating a first iteration codebook using the first iteration message deck;
recoding the first iteration message deck using the first iteration codebook;
repeating the propagating, generating, and recoding steps for at least a second iteration;
concatenating the message decks elementwise to form a final message deck;
row sorting the final message deck to form a row sorted message deck;
recoding the row sorted message deck to form a transform and a transform codebook;
row sorting the transform to form a row sorted transform; and
sorting rows of the row sorted transform to form the invariant.

29. The article of claim 28, wherein instructions to form the transform codebook comprise instructions to compute:
$$\hat{S} = {⋃}_{m = 1}^{n} {⋃}_{i = 1}^{n} {R}_{mi}$$
where Ŝ is the transform codebook, R is the row sorted message deck, n is the number of vertices in the graph, and m and i are indices of two of the dimensions of the row sorted message deck.

30. The article of claim 28, wherein instructions to form the transform comprise instructions to compute:
Sₘᵢ=E_{Ŝ}{Rₘᵢ}
where S is the transform, Ŝ is the transform codebook, and E is a recoding operator that recodes R according to codebook Ŝ.

31. The article of claim 28, wherein instructions to sort the rows of the row sorted transform comprise instructions to compute:
$${V}^{′} ( A ) = {⋃}_{m = \{ 1 , … , n \}} \{ {S}_{mm} ( A ) {⋃}_{i = \{ 1 , … , n \} \backslash m } \{ {S}_{mi} ( A ) \} \}$$
where V′ is the invariant, A is the adjacency matrix for the graph, S is the transform, n is the number of vertices in the graph, and m and i are indices of two of the dimensions of the transform.

32. A system for testing isomorphism of two graphs comprising:
an invariant generation module to accept an adjacency matrix for each graph and produce an invariant for each graph; and
an invariant comparison module coupled to the invariant generation module to accept the invariants, to compare the invariants, and to produce an isomorphism indicator;
wherein the invariant generation module is adapted to perform the following for each graph
initializing each card of an initial message deck to an identity matrix;
propagating messages to form a first iteration message deck using a message propagation rule;
generating a first iteration codebook using the first iteration message deck;
recoding the first iteration message deck using the first iteration codebook;
repeating the propagating, generating, and recoding steps for at least a second iteration;
concatenating the message decks elementwise to form a final message deck;
row sorting the final message deck to form a row sorted message deck;
recoding the row sorted message deck to form a transform and a transform codebook;
row sorting the transform to form a row sorted transform; and
sorting rows of the row sorted transform to form the invariant.

33. The system of claim 32, wherein the invariant generation module is adapted to form the transform codebook by computing:
$$\hat{S} = {⋃}_{m = 1}^{n} {⋃}_{i = 1}^{n} {R}_{mi}$$
where Ŝ is the transform codebook, R is the row sorted message deck, n is the number of vertices in the graph, and m and i are indices of two of the dimensions of the row sorted message deck.

34. The system of claim 32, wherein the invariant generation module is adapted to form the transform by computing:
Sₘᵢ=E_{Ŝ}{Rₘᵢ}
where S is the transform, S is the transform codebook, and E is a recoding operator that recodes R according to codebook Ŝ.

35. The system of claim 32, wherein the invariant generation module is adapted to sort the rows of the row sorted transform by computing:
$${V}^{′} ( A ) = {⋃}_{m = \{ 1 , … , n \}} \{ {S}_{mm} ( A ) {⋃}_{i = \{ 1 , … , n \} \backslash m} \{ {S}_{mi} ( A ) \} \}$$
where V″ is the invariant, A is the adjacency matrix for the graph, S is the transform, n is the number of vertices in the graph, and m and i are indices of two of the dimensions of the transform.
